(19) United States
(12) Patent Application Publication
(10) Pub. No.: US 2018/0241820 A1
(43) Pub. Date: Aug. 23, 2018

(54) SOFTWARE-DEFINED STORAGE APPARATUS, AND SYSTEM AND STORAGE METHOD THEREOF

(71) Applicant: Ambedded Technology Co., Ltd., Taipei City (TW)

(72) Inventor: JENN-LUN JOUE, Taipei City (TW)

(21) Appl. No.: 15/900,840

(22) Filed: Feb. 21, 2018

(30) Foreign Application Priority Data
Feb. 22, 2017 (TW) 106105938

(51) Int. Cl. H04L 29/08; H04L 12/24

(52) U.S. Cl. CPC H04L 67/1097; H04L 41/20

(57) ABSTRACT

The disclosure is related to a software-defined storage apparatus, a system and a storage method. The apparatus includes at least one packet-switched unit and multiple storage units. Each storage unit includes a server unit and a storage device. The server unit connects with the packet-switched unit via at least one network connection port, and connects with the storage device via a data transmission port. A plurality of software-defined storage apparatus forms a storage system. The multiple packet-switched units are respectively connected with an external switch. The server units in the different storage units are communicated with each other via a network communication protocol allowing the apparatus or the system to store data in a specific storage mode. The system can thereby achieve network connection redundancy. A data access redundancy can be achieved when the server units in each storage unit is connected to the multiple packet-switched units.

### BACKGROUND OF THE INVENTION

### 1. Field of the Invention

The disclosure is related to a storage apparatus and a storage method, and in particular to a software-defined storage apparatus using a chassis to contain a storage unit with a server and a storage device, and a system and storage method thereof.

### 2. Description of Related Art

Conventional data storage solutions generally adopt a computer chassis internally disposed or externally connected with a disc, a hard disk, or a magnetic tape; or alternatively, adopt a network-based storage solution. The network-based storage is such as a Network Attached Storage (NAS). In addition to the general purpose of storing data, the long-distance network-based storage solution also takes safety into consideration.

Generally, the data stored in a damaged hard disk may not be easily recovered if only one disk is used. Therefore, redundancy approaches such as the Redundant Array of Independent Disks (RAID) technology, that utilizes two or more hard disks to backup the data for recovery, have already been proposed by conventional storage technologies. The RAID technology provides the NAS solution with fault tolerance capabilities.

### SUMMARY OF THE INVENTION

The disclosure is related to a software-defined storage apparatus, a system, and a storage method for the same. The software-defined storage system provides a high availability network-based storage solution. The software-defined storage apparatus essentially includes at least one packet-switched unit that is used to connect with an external network, and a plurality of storage units. Each of the storage units includes a combination of one server unit and one storage device. The server unit connects with the packet-switched unit via a network port, and connects with the storage device via a data transmission port. The storage device is such as a hard disk or a Solid State Disk (SSD). Each network port of the server unit corresponds to an identification address.

In one embodiment of the present disclosure, the plurality of server units of the storage units are communicated with each other via a network communication protocol. The communication protocol allows the storage units to cooperatively store data in various storage modes. The server unit can include multiple network ports that individually connect with different packet-switched units. Therefore, the software-defined storage apparatus is able to implement data access redundancy.

In another embodiment, the packet-switched unit acts as a network switch inside the software-defined storage apparatus, and the software-defined storage apparatus connects with at least one external switch via the packet-switched unit. The software-defined storage apparatus can implement network connection redundancy if this storage apparatus includes multiple packet-switched units.

According to one embodiment of the software-defined storage system of the disclosure, the system can include multiple software-defined storage apparatuses. Each of the software-defined storage apparatuses has a plurality of packet-switched units and a plurality of storage units. The plurality of software-defined storage apparatuses are interconnected via one or more external switches so as to implement the software-defined storage system. Similarly, the server units of the storage units are communicated with each other via a network communication protocol. A storage mode can be used to store data. The multiple packet-switched units of one software-defined storage apparatus are respectively connected with one or more external switches, so that network connection redundancy can be implemented.

In one embodiment of the storage method performed by the software-defined storage apparatus, when data is received from a client device, the information attached to the data packets can be resolved so as to obtain a storage mode and one or more storage destinations. A storing algorithm in response to the storage mode is then executed by the apparatus. According to the one or more storage destinations obtained from the data packets, the data will be stored as a whole, or as distributed values after performing a distributed storing algorithm to one or more storage units. A data index that records a storage setting of the data is created.

Further, a storing algorithm program is executed in the client device utilizing the storage service of the system. The storing algorithm program records a profile for the software-defined storage system that is used to set the storage mode and compute the one or more storage destinations.

### BRIEF DESCRIPTION OF THE DRAWINGS

FIG. 1A and FIG. 1B show schematic diagrams depicting a basic configuration of a software-defined storage apparatus in one embodiment of the disclosure;

FIG. 2 shows a schematic diagram depicting a storage solution using the software-defined storage apparatus according to one embodiment of the disclosure;

FIG. 3 shows a schematic diagram of a network system adopting the software-defined storage apparatus in one embodiment of the disclosure;

FIG. 4 shows a schematic diagram depicting a storage solution adopting more than one of the software-defined storage apparatus in one embodiment of the disclosure;

FIG. 5 shows a flow chart describing a storage method of the software-defined storage apparatus according to one embodiment of the disclosure;

FIG. 6 shows another flow chart describing a storage method of more than one of the software-defined storage apparatus in another embodiment of the disclosure.

### DETAILED DESCRIPTION OF THE PREFERRED EMBODIMENTS

The present invention will now be described more fully with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

The disclosure is related to a software-defined storage apparatus, and a system and a storage method thereof. The invention provides a high availability and flexibility network-based storage solution. The software-defined storage apparatus acts as a minimum unit of the system, and can function independently. A combination of multiple software-defined storage apparatuses can constitute a software-defined storage system.

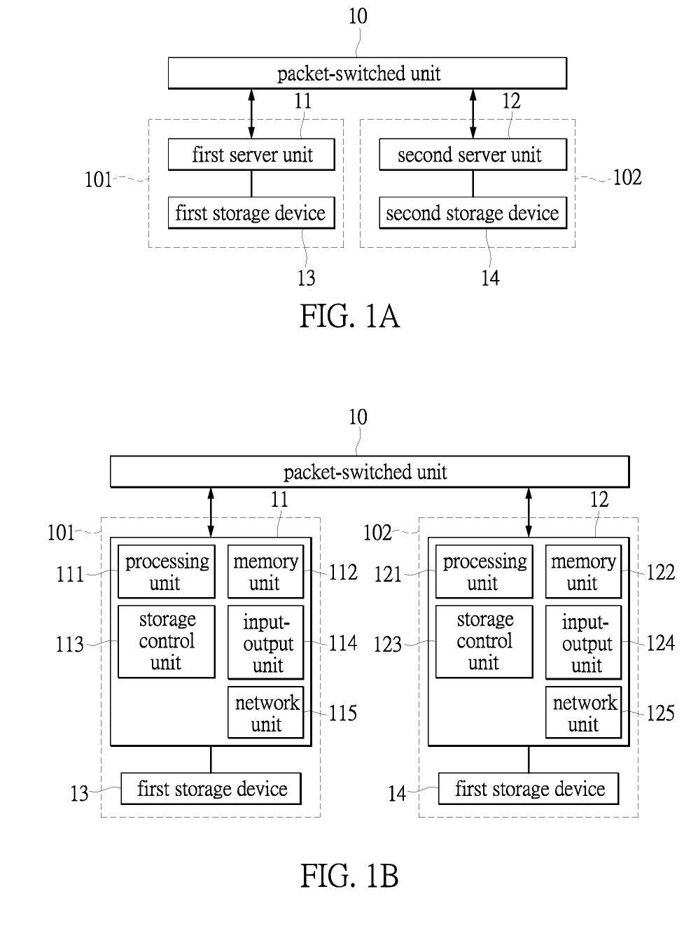

Reference is made to FIG. 1A showing a basic configuration of the software-defined storage apparatus according to one embodiment of the disclosure. The software-defined storage apparatus shown in the diagram can be disposed in a chassis. The apparatus includes at least one packet-switched unit 10 and a plurality of storage units that exemplarily has a first storage unit 101 and a second storage unit 102. The packet-switched unit 10 is used for connecting to an external network. Each of the storage units (101, 102) includes a server unit (11, 12) and a storage device (13, 14). For example, the first storage unit 101 has a first server unit 11 and a first storage device 13. One end of the first server unit 11 is connected with the packet-switched unit 10, and the other end is connected to the first storage device 13, thereby forming one of the storage units of the software-defined storage apparatus. Similarly, the second storage 102 of the software-defined storage apparatus can include a second server unit 12 and a second storage device 14.

Both the first and second server units 11, 12 connect with the packet-switched unit 10 via the respective network ports. Further, in one embodiment, the software-defined storage apparatus includes two or more packet-switched units 10. The first and the second server units 11 and 12 can concurrently connect with the two or more packet-switched units 10 to conduct load balancing. If any connection fails, e.g. port failure or line disconnection, the software-defined storage apparatus can achieve failover utilizing one of the connections to take over the original connection if the original connection fails. Meanwhile, the original connection port for the original connection will be terminated or forced into a sleep mode, such that the apparatus is not affected by connection failure. Further, each of the server units (11, 12) is configured to assign an identification address to each connection. The identification address can also be used to identify the storage unit (101, 102). The identification address can be an IP address assigned to each network port. The network port may be an RJ-45 connection port, but may also be other types of data transmission ports.

The storage device (13, 14) is such as a hard disk or a solid state drive (SSD). The first server unit 11 and the second server unit 12 are respectively connected with the first storage device 13 and the second storage device 14 via a data transmission port. The connection there-between can be implemented by a Serial Advanced Technology Attachment (SATA), or can also be implemented by other standards such as SCSI, IDE and PCI-E.

In the software-defined storage apparatus, a server unit of a storage unit is in charge of administrating a storage device. The server units (11, 12) of the storage units (101, 102) are communicated with each other by a network communication protocol. The server units (11, 12) are communicated through the packet-switched unit 10, and can store data under a specific storage mode. The network communication protocol regulates the data delivered between the packet-switched units for functions such as distributed storage, redundancy and load balancing, so that an index can be created for each data stored in the apparatus. When accessing the data, the indexes can be used for identifying the distribution of each segment of the data.

For example, under a distributed storage mode, both the first server unit 11 and the second server unit 12 receive an instruction for applying a distributed storing algorithm to a data. The data can be simultaneously distributed between the first storage device 13 and the second storage device 14 for the purpose of distributed storage.

FIG. 1B shows a schematic diagram depicting a software-defined storage apparatus in another embodiment of the disclosure. In the apparatus, the server units (11, 12) of each of the storage units (101, 102) adopt a micro-server architecture. The plurality of micro servers in the software-defined storage apparatus form a small-sized storage cluster. A plurality of software-defined storage apparatuses form a scalable large-sized storage cluster via network connections. The micro server stores the data transmitted from the client device into the storage device under a specific storage mode, in which the data is processed according to the storage mode prior to being stored.

An embedded operating system operated in the micro server is illustrated as the circuit blocks shown in FIG. 1B. The first server unit 11 of the first storage unit 101 essentially includes a processing unit 111, a memory unit 112, a storage control unit 113, an input-output unit 114 and a network unit 115. The first server unit 11 connects with at least one storage device, e.g. the first storage device 13. The processing unit 111 can be implemented by a processor that is used to process the data in accordance with a specific storage mode. For example, the processing unit 111 can be an ARM-based (Advanced RISC Machine) processor in the micro server. The memory unit 112 acts as a system memory in the micro server. The storage control unit 113 connects with a first storage device 13 corresponding to the first server unit 11. The storage control unit 113 can be a SATA controller that controls operation of the first storage device 13. The input-output unit 114 acts as an I/O circuit that processes the data inputted to or outputted from the micro server. The network unit 115 acts as the circuits that are used to process network packets with a network communication protocol. The network unit 115 includes one or more network ports that can connect with at least one packet-switched unit 10.

Similarly, the second server unit 12 essentially includes a processing unit 121, a memory unit 122, a storage control unit 123, an input-output unit 124 and a network unit 125.

According to the architecture of the software-defined storage apparatus schematically shown in FIG. 1A or FIG. 1B, the abovementioned micro server is configured to store the data transmitted from the client device into the storage device under a specific storage mode. In addition to performing general storing procedures, the operating process in the micro server is able to process a plurality of file formats of various file systems. This mechanism allows the software-defined storage apparatus to operate the various file systems supported by the various storage devices, as well as services such as a web server, a file server, a database, and a virtual host.

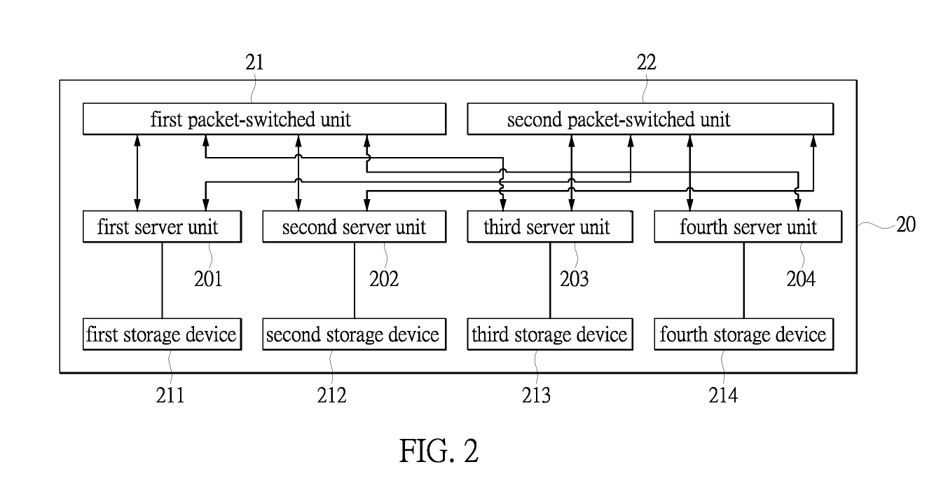

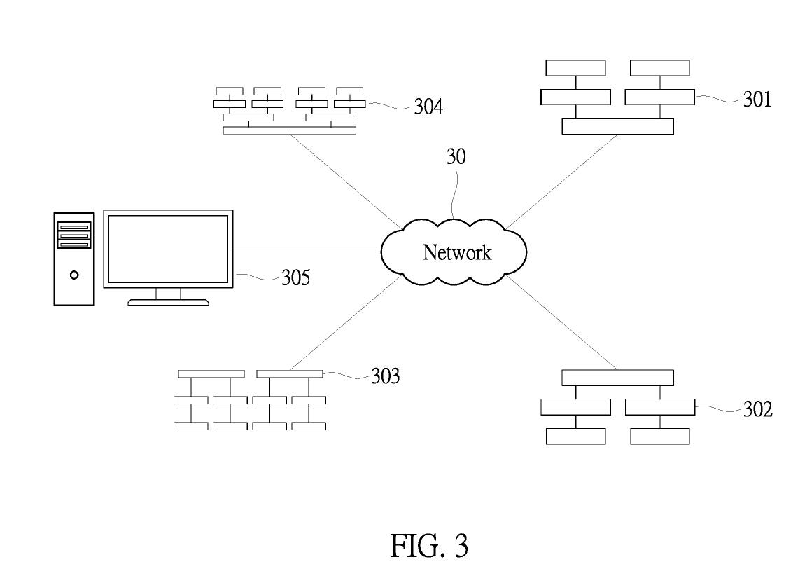

Reference is made to FIG. 2, depicting the software-defined storage apparatus in one further embodiment of the disclosure.

The software-defined storage apparatus 20 shown in the diagram is disposed in a chassis. The apparatus 20 includes two packet-switched units that can be within one single packet-switched circuit. The packet-switched units can be a network switch inside the software-defined storage apparatus 20. The network switch is used to connect with at least one external switch. The two packet-switched units are such as a combination of a first packet-switched unit 21 and a second packet-switched unit 22 that are interconnected via the external switch (not shown). The packet-switched units allow the multiple server units of the storage units of the software-defined storage apparatus 20 to be communicated with each other by a network communication protocol. The software-defined storage apparatus 20 therefore embodies a proprietary storing process.

In an exemplary example as shown in FIG. 2, four storage units are disposed in the software-defined storage apparatus. The four storage units are such as a first server unit 201 with a first storage device 211, a second server unit 202 with a second storage device 212, a third server unit 203 with a third storage device 213, and a fourth server unit 204 with a fourth storage device 214. Each server unit controls its connected storage device and performs a storing algorithm that stores the data as a whole or as distributed values, as required. The software-defined storage apparatus 20 accordingly achieves a data access redundancy by duplicating the data with one more copy, or implements fault tolerance using a parity hard disk.

Each of the server units 201, 202, 203 and 204 includes at least two or more network ports for respectively connecting with the first packet-switched unit 21 and the second packet-switched unit 22. This arrangement is generally used for conducting multiple route load balancing to solve network traffic congestion, and under certain circumstances for network connection redundancy. The network connection redundancy allows the network system to have failover capability. When any connection to the network fails, for example, when any failure occurs to one of the packet-switched units, another connection will take over according to the redundancy mechanism. The system can thereby await the recovery of the connection without affecting operations of the software-defined storage apparatus 20.

A software-defined storage system can be implemented when multiple software-defined storage apparatuses connect with each other via a network or a specific connection. Reference is made to FIG. 3, which illustrates a network architecture of the software-defined storage system in one embodiment of the disclosure.

FIG. 3 shows several types of the software-defined storage apparatuses 301, 302, 303 and 304 being connected via a network 30 of the system. The end device or system connects to the network 30 via one or more external switches.

It should be noted that the software-defined storage apparatus 301 and the software-defined storage apparatus 302 are exemplarily described in the embodiments shown in FIG. 1A and FIG. 1B, respectively. The software-defined storage apparatus 303, as shown in FIG. 2, includes multiple packet-switched units disposed in one chassis. The software-defined storage apparatus 304 implements a storage cluster defined by the plurality of software-defined storage apparatuses, so that the software-defined storage system can also be defined. The several types of the software-defined storage apparatuses shown in the diagram are only used to describe exemplary examples of the system, but do not limit the practical implementations of the system.

The software-defined storage system can form a large-sized network storage solution by connecting the multiple software-defined storage apparatuses and/or storage systems via the network 30. The storage unit in each software-defined storage apparatus includes a server unit and a storage device. The server units of the software-defined storage apparatuses can be communicated in compliance with a specific network communication protocol through the network 30 so as to provide more varied data storage solutions. The system achieves a data access redundancy service that is safer and that has higher reliability.

At the user end, such as the client device 305 shown in FIG. 3, a storing algorithm program is executed. The storing algorithm program saves a profile that records the settings of the entire software-defined storage system, including the plurality of software-defined storage apparatuses or the end system constituted by multiple storage apparatuses in the software-defined storage system. According to the above embodiments, the server unit of the storage unit of each software-defined storage apparatus connects to a specific server such as a host or a server program of the network 30. The profile also records the network-identifiable addresses with respect to the network ports. Thus, when a storing algorithm program is executed in the client device 305, one of the storage approaches can be selected. The storing algorithm program is used to set a storage mode in response to the selected approach and compute the one or more storage destinations. For example, under a distributed storage mode, the data to be stored will be divided into multiple segments which are transferred to one of the software-defined storage apparatuses 301, 302, 303 and 304, and the server units will compute the respective destinations of each of the storage units.

The software-defined storage system is a scalable system for the various storage approaches. It should be noted that any setting saved in the client device 305 should be updated if any change occurs in any of the software-defined storage apparatuses or any storage units of the storage system, e.g., a storage unit being added or removed.

For example, if the client device 305 is configured with a single-data storage approach, the storing algorithm program decides a storage address or adds a backup address according to the present profile. The storing algorithm program is performed to transfer the data to the storage destination. The aforementioned identification address is such as an IP address. When one of the server units of the system receives the data, the relational information attached with the data packets can be resolved. The storing algorithm is performed according the resolved storage mode. When the storage mode is a distributed storage approach, the storing algorithm program executed in the client device 305 obtains multiple storage destinations such as identification addresses. The server units with respect to a destination then perform a distributed storing algorithm for dividing the data into multiple segments according to the profile. The segments will then be respectively sent to the destination storage units through a specific network communication protocol operated among the multiple server units.

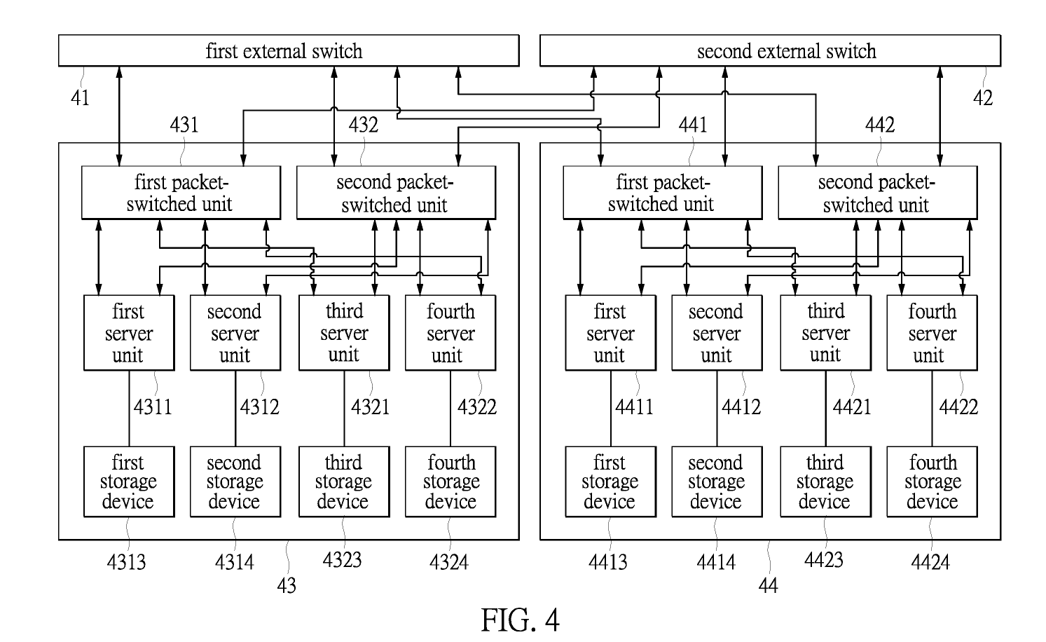

FIG. 4 next shows a schematic diagram depicting a storage system formed via an external switch interconnecting the software-defined storage apparatuses in one embodiment of the disclosure.

The software-defined storage apparatuses are such as a first software-defined storage apparatus 43 and a second software-defined storage apparatus 44. The packet-switched unit in each software-defined storage apparatus includes at least two network ports that are used to connect with the two external switches, e.g. the first external switch 41 and the second external switch 42. Thus, with the network connection redundancy implemented in the software-defined storage apparatus, the software-defined storage system can provide a much safer and more comprehensive redundancy solution with high reliability.

The first software-defined storage apparatus 43 internally includes a first packet-switched unit 431 and a second packet-switched unit 432 that are used to conduct a network connection redundancy. The packet-switched units 431 and 432 are respectively connected to the first external switch 41 and the second external switch 42 for external network connection. When one of the external switches fails, the other one can be switched in to connect with the external network.

In detail, the first software-defined storage apparatus 43 includes four standalone storage units. The four storage units will not interfere with each other, and when any one of them encounters a problem, the other storage units will not be affected. A first server unit 4311 connects with a first storage device 4313 via a specific data connection; a second server unit 4312 connects with a second storage device 4314; a third server unit 4321 connects with a third storage device 4323; and a fourth server unit 4322 connects with a fourth storage device 4324.

The second software-defined storage apparatus 44 similarly includes a first packet-switched unit 441, a second packet-switched unit 442, and four storage units. Included in the storage units are: a first server unit 4411 being connected to a first storage device 4413; a second server unit 4412 being connected to a second storage device 4414, a third server unit 4421 being connected to a third storage device 4423, and a fourth server unit 4422 being connected to a fourth storage device 4424. The integration of the server units 4411, 4412, 4421 and 4422 serve to provide a data storage and failover service. Moreover, a network connection redundancy can be achieved since every server unit is connected with a corresponding first packet-switched unit 441 or a second packet-switched unit 442.

By virtue of the first software-defined storage apparatus 43 and the second software-defined storage apparatus 44 being interconnected via the external switches, a storage system can be formed. The server units 4311, 4312, 4321, 4322, 4411, 4412, 4421 and 4422 are able to be communicated with each other via the network. The software-defined storage apparatuses 43 and 44 in the storage system can collaborate with each other to provide various storage solutions and data access redundancy.

The above embodiment shows the first software-defined storage apparatus 43 or the second software-defined storage apparatus 44 including four storage units that can be configured to operate, through a software program, a single-data storage approach, a backup approach or a distributed storage approach having fault tolerance mechanisms. While the first software-defined storage apparatus 43 and the second software-defined storage apparatus 44 are connected via the external switches 41 and 42, the system further provides more storage approaches with suitable storing algorithms. It should be noted that the numbers of the packet-switched units, the server units and the storage devices disclosed herein serve only to describe the system by example, but should not be construed as limiting the scope of the present disclosure.

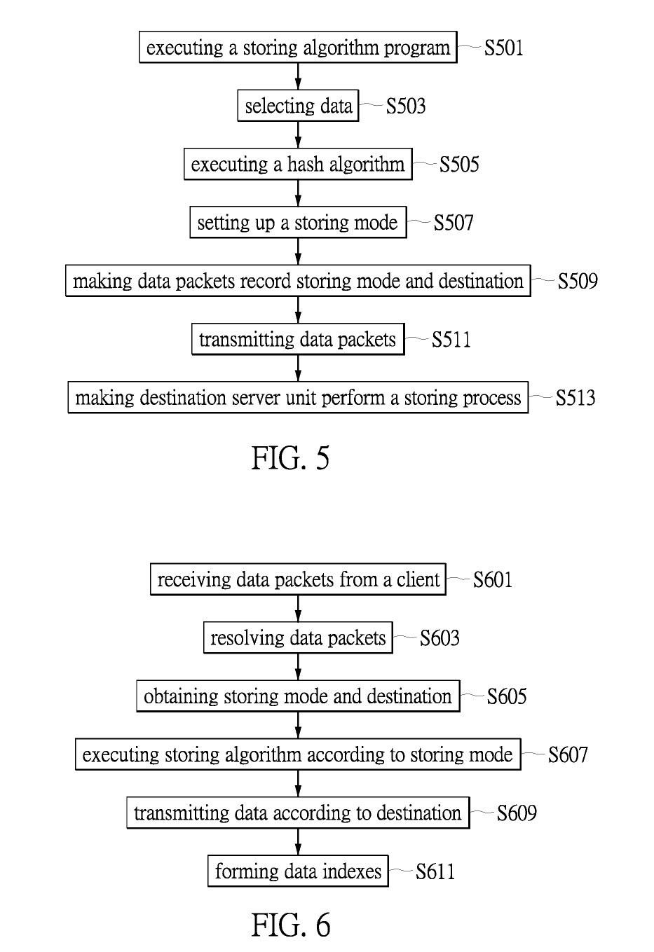

FIG. 5 shows a flow chart describing a storage method applied to the software-defined storage apparatus or the system according to one embodiment of the disclosure.

In step S501, a storing algorithm program is executed in a client device. The storing algorithm program is executed in response to a user configuration and a setting of the whole software-defined storage system. In step S503, a user selects a data to be stored in the system. An initial operation can be firstly executed in the device, as in step S505, and a hash algorithm is performed to transform the data into a specific hash string. The hash value calculated by the hash algorithm is irreversible and therefore is an effective approach to protect data and the relational information. In step S507, a storage mode is designated by the user. In step S509, the storing algorithm program computes one or more storage destinations according to the storage mode. The storage mode and the identification address(es) of the destination can be recorded in the hashed data packets. In step S511, the data packets are transmitted to one or more software-defined storage apparatuses corresponding to the destinations, and in step S513 the server units of the software-defined storage apparatus chooses one of the nodes to process the storage process. In step S513, the server unit at a destination performs data storing.

In addition to the data storage performed by the software-defined storage apparatus or system, the storing algorithm performed in the server units implements the distributed storage approach. The storing algorithm program executed in the client device is used to decide a storage mode and compute the storage destinations. The profile of the storing algorithm program records a setting for the software-defined storage system. A network topology of the software-defined storage system having the external switch(es), the packet-switched units and storage units of the software-defined storage apparatus can be recognized from the profile. The storing algorithm program executed in the client device also allows the user to retrieve the data stored by the data indexes that are formed in the storage process, so that the data can be recovered according to the data indexes.

FIG. 6 shows a flow chart describing a storage process of the system in one embodiment of the disclosure.

In step S601, when the data that is provided by the client device has been transmitted to the storage system, a server in the system, e.g. the server unit of the software-defined storage apparatus, receives the data packets formed by the data and its relational information. In step S603, the sequence executed in the server unit resolves the data packets. In step S605, a storage mode and the storage destination(s) can be obtained. In step S607, the server unit performs a storing algorithm according to the storage mode. The network communication protocol performed among the server units allows the server units of the system to perform a specific storage process collaboratively.

In step S609, one or more storage destinations can be obtained. The data is stored to one or more storage units as a whole or as the distributed values that are computed by a distributed storing algorithm. The data indexes corresponding to the distributed values computed in the server units are created, and the data indexes record a storage setting related to the data.

In step S611, the settings relating to the data includes data locations recorded in the data indexes. The settings also includes the locations to store the distributed values of the data after performing the distributed storing algorithm. The server unit can retrieve the data according to the data indexes that allows the system to search for and recover the data from distributed values.

Therefore, the above embodiments describe how the software-defined apparatus and system successfully achieve the mechanisms of a network connection redundancy and a data access redundancy. The architecture of the system includes a client device performing a storing algorithm program, a network switch, and multiple software-defined storage apparatuses that are connected via a network switch so as to provide a high reliability, scalable and varied storage solutions.

It is intended that the specification and depicted embodiments be considered exemplary only, with a true scope of the invention being determined by the broad meaning of the following claims.

What is claimed is:

1. A software-defined storage apparatus, comprising:
at least one packet-switched unit connected with an external network; and
a plurality of storage units, each of the storage units including a server unit and a storage device, wherein the server unit connects with the at least one packet-switched unit via at least one network port, and the server unit connects with the storage device via a data transmission port; and each network port of the server units has an identification address;
wherein the plurality of storage units are communicated with each other via a network communication protocol, and a storage mode is used in the software-defined storage apparatus to store a data.

2. The apparatus according to claim 1, wherein the packet-switched unit acts as a network switch inside the software-defined storage apparatus, and the software-defined storage apparatus connects with at least one external switch via the packet-switched unit.

3. The apparatus according to claim 2, wherein the at least one packet-switched unit respectively connects with one or more external switches for implementing network connection redundancy in the software-defined storage apparatus.

4. The apparatus according to claim 1, wherein the server unit of each of the storage units includes multiple network ports that respectively connect with one packet-switched unit, so as to implement data access redundancy in the software-defined storage apparatus.

5. The apparatus according to claim 4, wherein the different server units of the storage units in the software-defined storage apparatus are communicated with each other via a network communication protocol.

6. A software-defined storage system, comprising:
a plurality of software-defined storage apparatuses that are interconnected through one or more external switches, the software-defined storage apparatus including:
a plurality of packet-switched unit connected with an external network; and
a plurality of storage units, each of the storage units including a server unit and a storage device, wherein the server unit connects with the plurality of packet-switched units via a plurality of network ports, and the server unit connects with the storage device via a data transmission port; and each network port of the server units has an identification address;
wherein the plurality of storage units are communicated with each other via a network communication protocol, and a storage mode is used in the software-defined storage apparatus to store a data; and the plurality of packet-switched units of each of the software-defined storage apparatuses respectively connect with one or more external switches, so as to implement network connection redundancy in the software-defined storage apparatus.

7. The system according to claim 6, wherein the server unit of each of the storage units includes multiple network ports that respectively connect with one packet-switched unit, so as to implement data access redundancy in the software-defined storage apparatus.

8. The system according to claim 7, wherein the different server units of the storage units in each of the software-defined storage apparatuses are communicated with each other via a network communication protocol.

9. The system according to claim 6, wherein the packet-switched unit acts as a network switch inside the software-defined storage apparatus, and the software-defined storage apparatus connects with at least one external switch via the packet-switched unit.

10. A storage method, used to store a data to one or more software-defined storage apparatuses recited in claim 1, wherein the storage method comprises:
receiving data from a client device;
resolving relational information of the data for obtaining a storage mode and one or more storage destinations;
performing a storing algorithm according to the storage mode;
storing the data as a whole or as distributed values after performing a distributed storing algorithm to one or more storage units according to the one or more storage destinations; and
creating a data index that records a storage setting of the data.

11. The method according to claim 10, wherein one or more server units of the storage units in the one or more software-defined storage apparatuses receives the data and resolves relational information of the data so as to perform the storing algorithm according to the storage mode.

12. The method according to claim 11, wherein the storage destination is an identification address for identifying an address of each server unit.

13. The method according to 10, wherein a storing algorithm program is executed in the client device, and the storing algorithm program records a profile for a software-defined storage system that is used to set the storage mode and compute the one or more storage destinations; and the software-defined storage system includes a plurality of software-defined storage apparatuses.

14. The method according to claim 13, wherein one or more server units of the storage units in the one or more software-defined storage apparatuses receives the data and resolves relational information of the data so as to perform the storing algorithm according to the storage mode; and the storage destination is an identification address for identifying an address of each server unit.
